(19) United States
(12) Patent Application Publication
(10) Pub. No.: US 2011/0316662 A1
(43) Pub. Date: Dec. 29, 2011

(54) WINDING ARRANGEMENT FOR A TRANSFORMER OR FOR A THROTTLE

(75) Inventors: Helmut Pregartner, Krottendorf (AT); Mario Scala, Graz (AU)

(73) Assignee: Siemens Transformers Austria GMBH & CO. KG, Wien (AT)

(21) Appl. No.: 13/254,185

(22) PCT Filed: Sep. 3, 2009
(86) PCT No.: PCT/EP09/52712

§ 371 Date: Sep. 1, 2011

(51) Int. Cl. H01F 17/06

(52) U.S. Cl. 336/221

(57) ABSTRACT

A winding arrangement for a transformer or for a reactor is provided. The winding arrangement includes an annular winding cover part disposed on the front face of a winding, wherein a side surface of the winding cover part overlaps a front surface of the winding, wherein the annular winding cover part is designed to be magnetically conductive at least in a partial area and comprises a convex side surface facing away from the winding.

### CROSS REFERENCE TO RELATED APPLICATIONS

This application is the US National Stage of International Application No. PCT/EP2009/052712, filed Sep. 3, 2009 and claims the benefit thereof. All of the applications are incorporated by reference herein in their entirety.

### TECHNICAL FIELD

The invention relates to a winding arrangement for a transformer or for a reactor, having an annular winding cover part disposed on the end face of a winding, wherein a side surface of the winding cover part facing the winding overlaps an end face of the winding.

### PRIOR ART

In transformers or reactors with a high nominal power the electrical windings are usually concentrically arranged around a leg of a magnetically soft core and are conventionally permanently tensioned by a clamping structure. Forming part of this clamping structure are what are known as pressure rings or clamping rings with which the axial clamping force is distributed as uniformly as possible among the individual windings. The clamping rings are conventionally arranged between the end face of the windings and the yoke transverse to the leg.

A clamping ring of this kind for a power transformer is known for example from U.S. Pat. No. 3,750,070. This clamping ring comprises a body part which has the form of a disk. The two end faces of the disk are flat. With a side surface the disk rests with an intermediate layer of an insulating material respectively on the end faces of the windings. Radially extending grooves formed in the body part are filled with laminations to guide the magnetic flux leakage back into the transformer core in as low-loss a manner as possible.

A similar clamping ring which consists of a sheet coil also emerges from U.S. Pat. No. 3,366,907.

It is known that noises occur during operation of a transformer or a reactor which are undesirable for operation. Efforts are made to guide the magnetic flux in such a way that the magnetostriction and the forces acting on the conductor of the winding are as low as possible during operation.

The operating behavior of a transformer or a reactor can also be affected by peaks in the electrical voltage, however. Conductors of the winding that are located at the end face are at particular risk. If the electrical field strength exceeds a critical value in the region of the end face of a winding, a flashover can occur between winding and yoke. This can destroy the insulation of the winding.

To protect the insulation of a winding in a transformer against critical field strengths DE 35 34 843 A1 proposes a grading ring which is arranged at the end face of the winding. A special protective effect can be achieved thereby if the grading ring is galvanically connected to the respective edge conductor of the winding. The grading ring is domed at a side surface facing away from the winding, so critical values of the electrical field strength are avoided as far as possible. In contrast to the above-mentioned clamping rings, which do not have any electrostatic protective effect, this grading ring has only an electrical protective function. A grading ring is a separate component and therefore involves additional expenditure during production.

### DESCRIPTIONS OF THE INVENTION

The invention is based on the object of disclosing a winding arrangement for a transformer or for a reactor such that the operating behavior is improved as simply as possible and the winding is effectively electrostatically protected.

This object is achieved by a winding arrangement with the features of the claims. Advantageous developments of the invention are defined in the dependent claims.

At each end face of a winding the inventive winding arrangement comprises an annular winding cover part which is designed so as to be magnetically conductive at least in a partial area and comprises a convex side surface facing away from the winding. These two design features, the magnetic conductivity and the domed side surface, cooperate so as to promote a reduction in noise and an electrostatic protective effect.

The magnetically conducive design of the winding cover part firstly means that the magnetic field in the end region of the winding is guided in an axial direction of the leg core. The radial component of the magnetic field strength is therefore smaller in the region of the end face of the winding. The rotational symmetry of the flux guide is improved. As a result, the force acting on the conductor as well as eddy current losses in the windings and stator can be kept low during operation of a transformer or a reactor. Consequently less noise and lower losses occur. A low noise emission is particularly advantageous if the power transformer or the reactor is installed in the vicinity of a residential area. Since the loss distribution in the winding is more homogenous, advantages result in the thermal configuration. It is also very advantageous that small axial forces act on the electrical windings in the event of a short circuit.

At the same time the convex design of the side surface, toward the yoke, of the annular winding cover part is a simple way of producing an electrostatic shield. The equipotential surfaces are no longer located close together in the end region of the electrostatic shield but are more spaced apart. The change in the electrical potential and therewith the electrical field strength is less. The end-face edges of a winding are better protected from critical electrical field strengths since the gentle curvature of the side surface alleviates the problem of what is known as the “point effect”. As a result, the risk of a flashover between winding and magnetic core is thereby lower compared with an unshielded winding.

A particularly simple construction can be characterized in that the annular winding cover part is produced completely from a flat or radially layered laminated core or a winding of a ferromagnetic material or the combination thereof. The side surface of the laminated core remote from the winding or the angle is convex. The winding cover part therefore functions as a magnetic flux guide part and as an electrical shield. Metal sheets can advantageously be used during production, as are used in the manufacture of the core of the transformer or reactor anyway. For handling it may be advantageous if the individual lamellae of the toroidal laminated core are held together by an adhesive.

A further embodiment can be constructed in such a way that the winding cover part comprises a body formed from an insulating material in which one or more lamination core(s) is/are inserted or embedded. The body part can have the form of a torus section whose circumferential surface is surrounded by an electrical shield. The capacitive coupling between shield and edge conductors of the winding brings about an electrostatic shielding effect. Conventional insulating material, such as pressboard and wood, can advantageously be used for the body part.

A particularly good shielding effect may be achieved in that the laminated core or the shield is electrically connected to an edge conductor of the winding by means of an electrical contact device known per se. Very effective electrostatic shielding and at the same time advantageous influencing of the magnetic flux may be achieved thereby.

It may be advantageous if the laminated core embedded in the body part of the winding cover part is composed of a plurality of layers. These layers may be arranged so as to lie one above the other in a staggered manner. In terms of form and material characteristics the individual layers are designed in such a way that the radial component of the magnetic flux density is reduced as far as possible in the end region. The vibration excitation caused by the magnetostriction, and as a consequence thereof the emitted sound power, are lower as a result. The eddy current losses in the magnetic core are also lower. Smaller short circuit forces act on the conductors of the windings in the event of a short circuit.

The electrical shield may be easily produced by way of taping of the body part with an electrically conductive strip material or with a wire mesh or a wire web.

However, it is also conceivable for the electrical shield to be produced in that the surface of the body part is electrically conductively coated, by way of example by applying a conductive powder.

To design the winding cover part so as to be magnetically conductive at least in a partial area, magnetically soft molded sintered parts may also be used as an alternative to a laminated core. The entire winding cover part can consist of a single permeable solid body or be composed of sintered parts. The magnetically soft solid body or the sintered parts can also be inserted or embedded in an insulating body part.

It may be advantageous for the electrostatic shielding effect if the molded sintered part has the form of a torus section and is pulled down in the manner of a bead at the side toward the winding. It may be advantageous here for the side surface toward the winding to be constructed so as to continuously merge with the convex side surface. Since there are no sharp edges the point effect of the electrical field strength is diminished. The risk of an electrical flashover between winding and yoke is lower as a result.

A polymer material may also be used in addition to the insulating materials already mentioned for producing the body part of the winding cover part. An embodiment in plastic has, by way of example, the advantage that owing to the resilient property of the (injection) molding material, the propagation of vibrations is attenuated.

In a preferred embodiment it may be provided that an insulating layer is arranged between the end face of the winding and opposing side surface of the winding cover part.

An embodiment of the invention is also preferred in which the winding consists of a plurality of part windings arranged concentrically around a leg axis and each end face of these hollow cylindrical winding parts is separately covered by a winding cover part respectively. Each winding part is effectively electrostatically shielded from the adjacent yoke part thereby.

In a preferred construction the winding cover parts are incorporated in a magnetic flux, which is induced by a supporting and tensioning device, with the supporting and tensioning device being supported on an upper and/or on a lower yoke part of the transformer or the reactor.

It may be advantageous in this connection if the convex side surface has a flat portion in a central region. The clamping force is transferred to a correspondingly large circular ring as a result.

It is expedient if a sheet metal material is used when producing the laminated core or the tape wound core, as is also used when producing the yoke or the leg of the transformer or reactor.

### BRIEF DESCRIPTION OF THE DRAWINGS

For further explanation of the invention reference will be made in the following part of the description to the drawings in which further advantageous embodiments, details and developments of the invention can be found and in which:

FIG. 1 shows a power transformer in a view from above in the direction of the leg axis, having an inventive winding arrangement,

FIG. 2 shows a sectional drawing according to line A-A of FIG. 1,

FIG. 3 shows an enlarged diagram of detail X in FIG. 2 in which the pattern of the magnetic field lines in the region of the end faces of the transformer windings is shown, inventive winding cover elements being present,

FIG. 4 shows a diagram of the field pattern as in FIG. 3 but without the inventive winding cover parts,

FIG. 5 shows in an enlarged cross-section a winding cover part which is produced from laminations of a ferromagnetic material,

FIG. 6 shows in an enlarged cross-section a winding cover part, the magnetically conductive partial area being formed by embedding laminated cores in the body part,

FIG. 7 shows in an enlarged cross-section a winding cover part, the magnetically conductive partial area being a molded sintered part,

FIG. 8 shows a winding cover part according to FIG. 7, an edge region of the body part being pulled down in the manner of a bead on either side of the winding.

### EXECUTION OF THE INVENTION

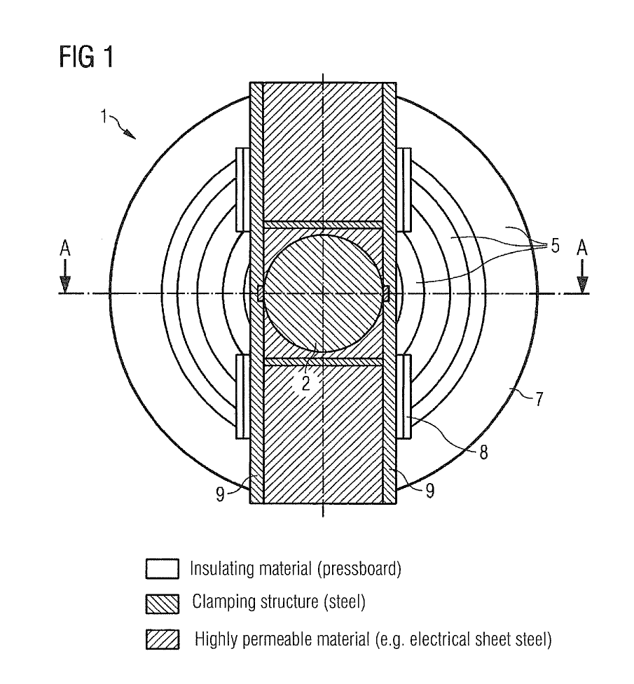

FIG. 1 shows a transformer 1 in the region of a transformer leg 2 which supports a winding 5 consisting of a plurality of parts. The individual parts of the winding 5 are concentrically arranged around a leg axis 4. A supporting and tensioning device 8 formed from insulating material (pressboard) presses onto a clamping ring 7. The supporting and tensioning device 8 is supported on yoke end plates 9. The transformer leg 2 is made from highly permeable electrical sheet steel.

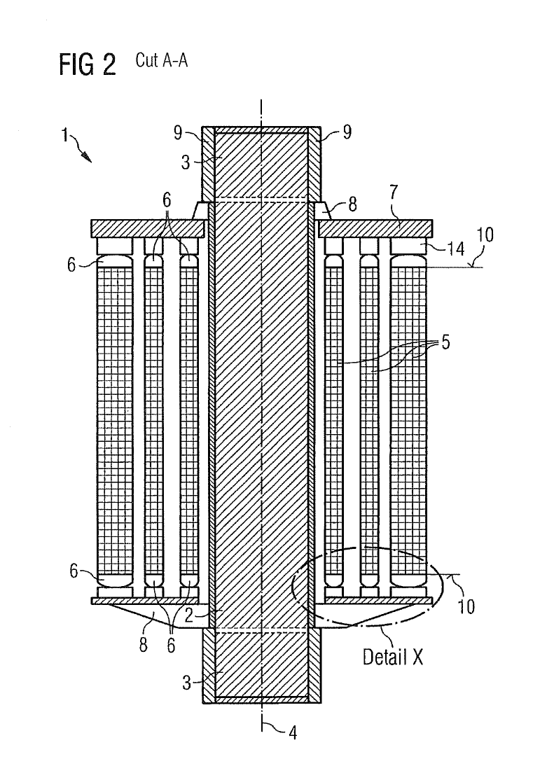

The drawing of FIG. 2 shows a sectional drawing according to line A-A of FIG. 1. The supporting and tensioning device 8 compresses the individual windings 5 in the axial direction (direction of the leg axis 4). The winding cover parts 6, which are each arranged on the end faces of the winding parts 5, are located in the magnetic flux. As described in more detail below with exemplary embodiments, the winding cover parts 6 bring about guidance of the magnetic flux in the end region of the winding 5 on the one hand, and on the other hand they constitute a barrier for an electrical flashover between winding and yoke. Owing to their magnetic conductivity the winding cover parts 6 will hereinafter also be called permeable rings for short. The contact force generated by the supporting and tensioning device 8 is transmitted via a clamping ring 7 and by means of force-transmitting elements 14 respectively, not shown in detail, to the permeable rings 6. Each of these permeable rings 6 covers an end face 10 of a winding 5 in each case.

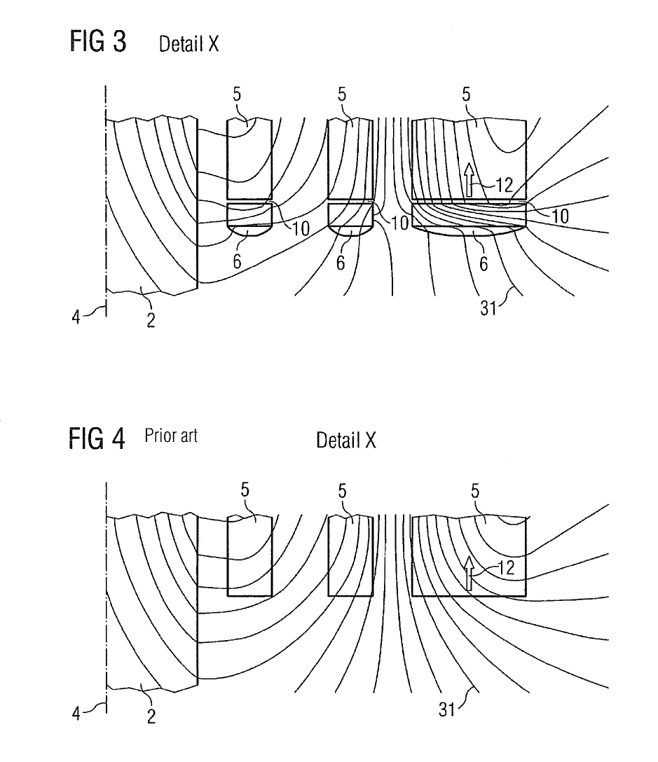

FIG. 3 shows in an enlarged diagram the detail X from FIG. 2. As already stated, the magnetically conductive embodiment of the winding cover part 6 induces the magnetic field lines 3 to be guided in a direction parallel to the leg axis 4. This deflection becomes clear if the magnetic field lines 3 in FIG. 3 are compared with those in FIG. 4, where the field image is likewise shown in the region of the end faces. There are no permeable rings in FIG. 4 (prior art) in contrast to FIG. 3, however.

As a result, this comparison of FIG. 3 with FIG. 4 makes it clear that due to the inventive winding arrangement, in which the end faces of the windings 5 are covered by magnetically conductive rings 6, the radial component allows the magnetic field strength to be reduced in the region of the end faces. A smaller radial component improves the rotational symmetry of the flux with respect to the leg axis 4. The scattering losses are lower as a result. The axial force 12 acting on the individual conductors of the winding 5 is lower in each case due to the invention (the size of the axial force is shown in FIGS. 3 and 4 by an arrow in each case). The lower force effect on the conductors improves the oppressive noise emission. The mechanical stress acting on the winding is also lower in the case of an electrical short circuit.

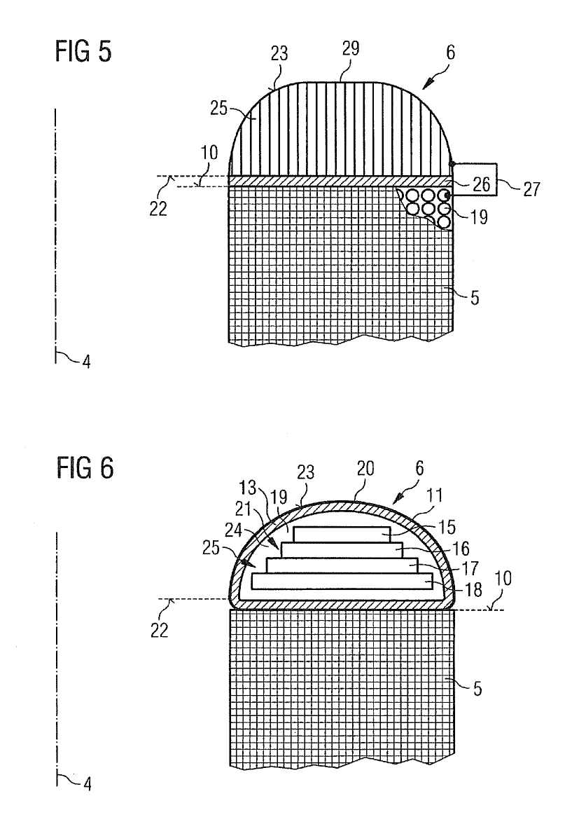

The drawing of FIG. 5 shows an enlarged winding cover part 6 in cross-section. The front end of a winding 5 is shown. The winding cover part 6 has the form of a torus section. This domed ring rests with a flat side or ring surface 22 toward the winding 5, with an intermediate layer of an insulating layer 26, on the end face 10 of the winding 5. The end face 10 is completely covered as a result. The ring surface 23 facing away from the end face 10 is convex when viewed in cross-section and is provided with a flat portion 29 in a central region. The permeable ring 6 is formed by a laminated core 25 here. The individual lamellae of the laminated core 25 are oriented in the direction of the leg axis 4 and held together by an adhesive. An electrical contact device 27 contacts the laminated core 25 with an edge conductor 19 of the winding 5.

FIG. 6, by contrast, shows an embodiment of the invention in which the body 24 of the winding cover part 6 comprises an electrical insulator (pressboard) in which a laminated core 25 comprising a plurality of layers 15, 16, 17, 18 is embedded. The laminated core 25 forms the magnetically conductive partial area 21 inside the body part 24. The body part 24 has the shape of a torus section in this embodiment of the invention as well. The circumferential surface of the torus section is surrounded by an electrical shield 13. The shield 13 consists of a taping with an electrical conductive strip material but may also be a wire web or a coating. The shield 13 envelops the entire surface of the body part 24 here and forms an equipotential surface. The annular dome 11 is dimensioned such that the electrical field strength is as low as possible. The winding 5 is consequently well protected from electrical flashovers at the end face. The individual layers 15, 16, 17, 18 are formed by laminated cores and tape wound cores which are each produced from a ferromagnetic material and are stacked on top of one another in a staggered manner. The enveloping surface of the electrical shield 13 is surrounded by an electrical insulation 20. The convex side surface 23 points in the direction of the magnetic yoke, which is not shown in detail here. The side surface 22 pointing toward the winding 5 rests on the end face 10 of the winding 5.

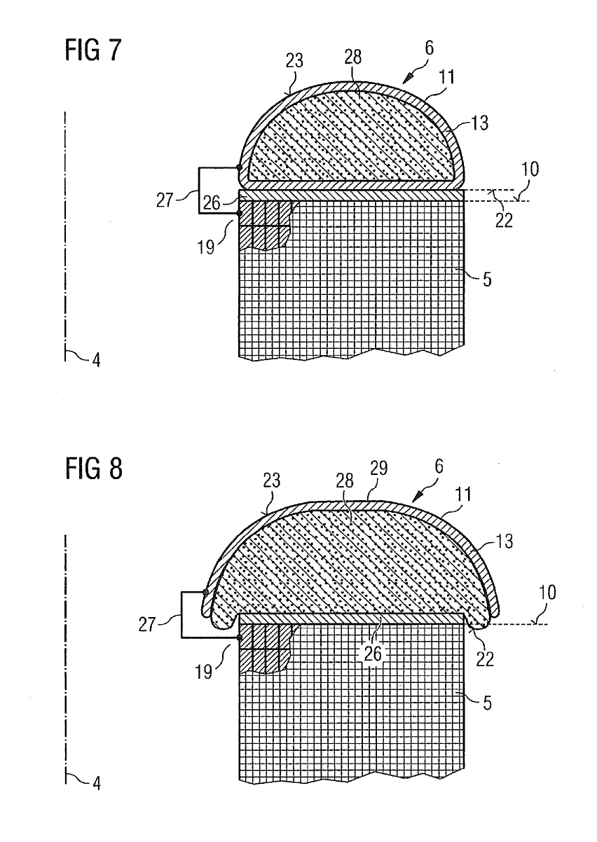

FIG. 7 shows a further embodiment in which the permeable ring 6 is formed from a molded sinter part 28. The molded sintered part 28 again has the form of a ring domed toward the yoke. The molded sintered part 28 is surrounded by a shield 13. The shield 13 is electrically connected to an electrical contact device 27 by a conductor 19 of the winding 5 located on the edge of the winding. An insulating layer 26 is also arranged here between the side surface 22 and the end face 10.

FIG. 8 shows an embodiment that is slightly modified with respect to FIG. 7. Here the side surface 22 of the winding cover part 6 located toward the winding 5 is wider. The bead-like edge of the molded sintered part 28 is pulled down slightly to the left and right of the winding 5. An insulating layer 26 is located between the molded sintered part 28 and the end face 10 of the winding 5. The convex side surface 23 merges continuously into the side surface 22. There are no sharp edges therefore. The convex side surface 23 is provided with an electrical shield 13 in the region of the dome 11, and this is produced by a surface coating. The electrical potential of the shield 13 is again at the potential of the edge conductor 19 of the winding 5 by means of the contact device 27. The convex curvature of the dome 11 is in each case designed in such a way that the critical field strength for an electrical flashover between winding and yoke is not attained during operation.

1.-15. (canceled)

16. A winding arrangement for a transformer or for a reactor, comprising:
an annular winding cover part disposed on an end face of a winding,
wherein a side surface of the winding cover part facing a winding overlaps the end face of the winding, and
wherein the annular winding cover part is designed to be magnetically conductive at least in a partial area and comprises a convex side surface facing away from the winding.

17. The winding arrangement as claimed in claim 16, wherein the annular winding cover part is fanned from a laminated core of a ferromagnetic material.

18. The winding arrangement as claimed in claim 16,
wherein the annular winding cover part comprises a body part,
wherein the magnetically conductive partial area is formed from a laminated core which is embedded in the body part, and
wherein the body part is surrounded by an electrical shield.

19. The winding arrangement as claimed in claim 18, wherein the laminated core is connected by means of an electrical contact device to an edge conductor of the electrical winding.

20. The winding arrangement as claimed in claim 18, wherein the electrical shield is connected by means of an electrical contact device to an edge conductor of the electrical winding.

21. The winding arrangement as claimed in claim 18, wherein the laminated core is composed of a plurality of layers located one above the other in a staggered manner.

22. The winding arrangement as claimed in claim 19, wherein the laminated core is composed of a plurality of layers located one above the other in a staggered manner.

23. The winding arrangement as claimed in claim 18, wherein the electrical shield is produced by wrapping the annular body part in an electrically conductive strip.

24. The winding arrangement as claimed in claim 18, wherein the electrical shield is produced by wrapping the annular body part in a wire mesh.

25. The winding arrangement as claimed in claim 18, wherein the electrical shield is formed by coating a surface of the body part.

26. The winding arrangement as claimed in claim 16, wherein the magnetically conductive partial area is formed by a permeable molded sintered part.

27. The winding arrangement as claimed in claim 26, wherein the molded sintered part includes a form of a torus section, in that the side surface of the winding cover part projects beyond the end face of the winding and is constructed so as to continuously merge with the convex side surface.

28. The winding arrangement as claimed in claim 18, wherein the body part is produced from a polymer material.

29. The winding arrangement as claimed in claim 16, wherein an insulating layer is arranged between the end face and the side surface.

30. The winding arrangement as claimed in claim 16, wherein the winding is formed from a plurality of winding parts which are concentrically arranged around a leg axis and each end face of a winding part is covered by an associated winding cover part respectively.

31. The winding arrangement as claimed in claim 30, wherein each winding cover part is integrated in a magnetic flux, acting in a direction of the leg axis, which is induced by a supporting and tensioning device, which is supported on an upper and on a lower yoke of the transformer or the reactor.

32. The winding arrangement as claimed in claim 30, wherein each winding cover part is integrated in a magnetic flux, acting in a direction of the leg axis, which is induced by a supporting and tensioning device, which is supported on an upper or on a lower yoke of the transformer or the reactor.

33. The winding arrangement as claimed in claim 32, wherein each winding cover part is provided with a flat portion at the convex side surface.

34. The winding arrangement as claimed in claim 17, wherein the same ferromagnetic material is used for the laminated core as for the core of the transformer or reactor.
